(19) United States
(12) Patent Application Publication
(10) Pub. No.: US 2005/0052894 A1
(43) Pub. Date: Mar. 10, 2005

(54) Uses of nanofabric-based electro-mechanical switches

(75) Inventors: Brent M. Segal, Woburn, MA (US); Thomas Rueckes, Boston, MA (US)

Correspondence Address: WILMER CUTLER PICKERING HALE AND DORR LLP, 60 STATE STREET, BOSTON, MA, 02109, US

(73) Assignee: Nantero, Inc.

(21) Appl. No.: 10/935,994

(22) Filed: Sep. 8, 2004

Related U.S. Application Data
(60) Provisional application No. 60/501,042, filed on Sep. 9, 2003.
(60) Provisional application No. 60/503,173, filed on Sep. 15, 2003.

(51) Int. Cl. H01H 9/20

(52) U.S. Cl. 365/129

(57) ABSTRACT

Uses of electromechanical nanoswitches made from preformed carbon nanotube films, layers, fabrics, ribbons, are disclosed.

### CROSS-REFERENCE TO RELATED APPLICATIONS

This application claims the benefit under 35 U.S.C. § 119(e) of U.S. Provisional Patent Application Nos. 60/501,042, filed Sep. 8, 2003, and 60/503,173, filed Sep. 15, 2003, both entitled Uses of Nanofabric-Based Electro-Mechanical Switches, which are herein incorporated by reference in their entirety.

### BACKGROUND

1. Field of the Invention

The present application relates generally to uses of nanofabric-based electro mechanical switches.

2. Discussion of Related Art

Nanotubes are useful for many applications; due to their electrical properties nanotubes may be used as conducting and semi-conducting elements in numerous electronic elements. Single walled carbon nanotubes (SWNTs) have emerged in the last decade as advanced materials exhibiting interesting electrical, mechanical and optical properties.

Individual nanotubes may be used as conducting elements, e.g. as a channel in a transistor, however the placement of millions of catalyst particles and the growth of millions of properly aligned nanotubes of specific length presents serious challenges. U.S. Pat. Nos. 6,643,165 and 6,574,130 describe electromechanical switches using flexible nanotube-based fabrics (nanofabrics).

Recently, memory devices have been proposed which use nanoscopic wires, such as single-walled carbon nanotubes, to form crossbar junctions to serve as memory cells. See WO 01/03208, Nanoscopic Wire-Based Devices, Arrays, and Methods of Their Manufacture; and Thomas Rueckes et al., “Carbon Nanotube-Based Nonvolatile Random Access Memory for Molecular Computing,” Science, vol. 289, pp. 94-97, 7 Jul. 2000. Electrical signals are written to one or both wires to cause them to physically attract or repel relative to one another. Each physical state (i.e., attracted or repelled wires) corresponds to an electrical state. Repelled wires are an open circuit junction. Attracted wires are a closed state forming a rectified junction. When electrical power is removed from the junction, the wires retain their physical (and thus electrical) state thereby forming a non-volatile memory cell.

The use of an electromechanical bi-stable device for digital information storage has also been suggested (c.f. U.S. Pat. No. 4,979,149: Non-volatile memory device including a micro-mechanical storage element).

The creation and operation of a bi-stable nano-electro-mechanical switches based on carbon nanotubes (including mono-layers constructed thereof) and metal electrodes has been detailed in a previous patent application of Nantero, Inc. (U.S. Pat. Nos. 6,574,130, 6,643,165, 6706402; U.S. patent application Ser. Nos. 09/915,093, 10/033,323, 10/033,032, 10/128,117, 10/341,005, 10/341,055, 10/341,054, 10/341,130, 10/776,059, and 10/776,572, the contents of which are hereby incorporated by reference in their entireties).

There is a need, generally in the field of electronics to create ever smaller and more efficient electronic elements; the inventors apply carbon nanotube technology to attain this goal.

### SUMMARY

According to one aspect of the invention, a nanofabric switch is used as an element in or to control an active device.

According to one aspect of the invention, a nanofabric switch is used as an element in or to control an application-specific integrated circuit (ASIC).

According to one aspect of the invention, a nanofabric switch is used as an element in or to control a logic array (uncommitted logic array).

According to one aspect of the invention, a nanofabric switch is used as an element in or to control an asynchronous circuit.

According to one aspect of the invention, a nanofabric switch is used as an element in or to control a charge pump.

According to one aspect of the invention, a nanofabric switch is used as an element in or to control a circuit element.

According to one aspect of the invention, a nanofabric switch is used as an element in or to control an active circuit element.

According to one aspect of the invention, a nanofabric switch is used as an element in or to control a parasitic circuit element.

According to one aspect of the invention, a nanofabric switch is used as an element in or to control a passive circuit element.

According to one aspect of the invention, a nanofabric switch is used as an element in or to control an electrical connection (e.g. within a semiconductor device).

According to one aspect of the invention, a nanofabric switch is used as an element in or to control a semiconductor diode.

According to one aspect of the invention, a nanofabric switch is used as an element in or to control a discrete (semiconductor) device, e.g. a diode, a transistor, a rectifier, a thyristor, or multiple versions of these devices, e.g. complex Darlington transistors.

According to one aspect of the invention, a nanofabric switch is used as an element in or to control a logic gate; a combinational logic function consisting of a number of inputs and outputs and performing one of the Boolean functions AND, OR, exclusive OR, NAND, NOR, or exclusive NOR. NOTE For the purpose of specifying complexity, (1) buffers and inverters are counted as gates and (2) exclusive OR and exclusive NOR gates, some high-input-count gates, and memory functions are counted as multiple gates.

According to one aspect of the invention, a nanofabric switch is used as an element in or to control a Schmitt trigger.

According to one aspect of the invention, a nanofabric switch is used as an element in or to control a collector field-effect transistor.

According to one aspect of the invention, a nanofabric switch is used as an element in or to control a source, whose gate is connected to the substrate.

According to one aspect of the invention, a nanofabric switch is used as an element in or to control a field-effect transistor (FET).

According to one aspect of the invention, a nanofabric switch is used as an element in or to control an insulated-gate field-effect transistor (IGFET).

According to one aspect of the invention, a nanofabric switch is used as an element in or to control a junction-gate field-effect transistor (JFET).

According to one aspect of the invention, a nanofabric switch is used as an element in or to control a lateral transistor.

According to one aspect of the invention, a nanofabric switch is used as an element in or to control a metal-oxide-semiconductor field-effect transistor (MOSFET).

According to one aspect of the invention, a nanofabric switch is used as an element in or to control a substrate pnp transistor.

According to one aspect of the invention, a nanofabric switch is used as an element in or to control a unipolar transistor.

According to one aspect of the invention, a nanofabric switch is used as an element in or to control a via.

According to one aspect of the invention, a nanofabric switch is used as an element in or to control a cell compiler.

According to one aspect of the invention, a nanofabric switch is used as an element in or to control a logic interconnection.

According to one aspect of the invention, a nanofabric switch is used as an element in or to control a channelless gate array.

According to one aspect of the invention, a nanofabric switch is used as an element in or to control a field-programmable gate array.

According to one aspect of the invention, a nanofabric switch is used as an element in or to control a field-programmable logic array (FPLA).

According to one aspect of the invention, a nanofabric switch is used as an element in or to control a field-programmable logic sequencer (FPLS).

According to one aspect of the invention, a nanofabric switch is used as an element in or to control a gate array integrated circuit.

According to one aspect of the invention, a nanofabric switch is used as an element in or to control a hardware accelerator.

According to one aspect of the invention, a nanofabric switch is used as an element in or to control a macrocell.

According to one aspect of the invention, a nanofabric switch is used as an element in or to control a primitive, i.e. a basic building block for a specified level of design hierarchy.

According to one aspect of the invention, a nanofabric switch is used as an element in or to control a process-programmable gate array.

According to one aspect of the invention, a nanofabric switch is used as an element in or to control a programmable logic array (PLA).

According to one aspect of the invention, a nanofabric switch is used as an element in or to control a programmable logic sequencer (PLS).

According to one aspect of the invention, a nanofabric switch is used as an element in or to control a silicon compiler.

According to one aspect of the invention, a nanofabric switch is used as an element in or to control a sink driver, (current-).

According to one aspect of the invention, a nanofabric switch is used as an element in or to control a source driver, (current-).

According to one aspect of the invention, a nanofabric switch is used as an element in or to control (bipolar) outputs.

According to one aspect of the invention, a nanofabric switch is used as an element in or to control a three-state output.

According to one aspect of the invention, a nanofabric switch is used as an element in or to control a unipolar output.

According to one aspect of the invention, a nanofabric switch is used as an element in or to control a balanced amplifier.

According to one aspect of the invention, a nanofabric switch is used as an element in or to control differential inputs.

According to one aspect of the invention, a nanofabric switch is used as an element in or to control differential outputs.

According to one aspect of the invention, a nanofabric switch is used as an element in or to control an analog gate.

According to one aspect of the invention, a nanofabric switch is used as an element in or to control a buffer.

According to one aspect of the invention, a nanofabric switch is used as an element in or to control a bus driver.

According to one aspect of the invention, a nanofabric switch is used as an element in or to control a bus receiver.

According to one aspect of the invention, a nanofabric switch is used as an element in or to control a clock driver.

According to one aspect of the invention, a nanofabric switch is used as an element in or to control a differential voltage comparator.

According to one aspect of the invention, a nanofabric switch is used as an element in or to control a decoder.

According to one aspect of the invention, a nanofabric switch is used as an element in or to control a differential line receiver.

According to one aspect of the invention, a nanofabric switch is used as an element in or to control a differential video amplifier.

According to one aspect of the invention, a nanofabric switch is used as an element in or to control a digital-to-analog [D/A] converter (DAC).

According to one aspect of the invention, a nanofabric switch is used as an element in or to control a driver.

According to one aspect of the invention, a nanofabric switch is used as an element in or to control an encoder.

According to one aspect of the invention, a nanofabric switch is used as an element in or to control an interface integrated circuit.

According to one aspect of the invention, a nanofabric switch is used as an element in or to control a line driver.

According to one aspect of the invention, a nanofabric switch is used as an element in or to control a line receiver.

According to one aspect of the invention, a nanofabric switch is used as an element in or to control a logic-level converter/logic-level translator.

According to one aspect of the invention, a nanofabric switch is used as an element in or to control a peripheral driver.

According to one aspect of the invention, a nanofabric switch is used as an element in or to control a memory sense amplifier.

According to one aspect of the invention, a nanofabric switch is used as an element in or to control a sink LED decoder driver.

According to one aspect of the invention, a nanofabric switch is used as an element in or to control a source LED decoder driver.

According to one aspect of the invention, a nanofabric switch is used as an element in or to control a universal asynchronous receiver transmitter (UART).

According to one aspect of the invention, a nanofabric switch is used as an element in or to control a video amplifier.

According to one aspect of the invention, a nanofabric switch is used as an element in or to control an analog-to-digital [A/D] converter (ADC).

According to one aspect of the invention, a nanofabric switch is used as an element in or to control an analog-to-digital processor.

According to one aspect of the invention, a nanofabric switch is used as an element in or to control a series control element (series pass element).

According to one aspect of the invention, a nanofabric switch is used as an element in or to control a bucket-brigade device (BBD).

According to one aspect of the invention, a nanofabric switch is used as an element in or to control a bulk-channel charge-coupled device (BCCD).

According to one aspect of the invention, a nanofabric switch is used as an element in or to control a buried-channel charge-coupled device (BCCD).

According to one aspect of the invention, a nanofabric switch is used as an element in or to control a charge-coupled device (CCD).

According to one aspect of the invention, a nanofabric switch is used as an element in or to control a charge-coupled image sensor.

According to one aspect of the invention, a nanofabric switch is used as an element in or to control a charge-transfer device (CTD).

According to one aspect of the invention, a nanofabric switch is used as an element in or to control a conductivity-connected charge-coupled device (C4D).

According to one aspect of the invention, a nanofabric switch is used as an element in or to control a junction-gate charge-coupled device.

According to one aspect of the invention, a nanofabric switch is used as an element in or to control an n-channel charge-coupled device.

According to one aspect of the invention, a nanofabric switch is used as an element in or to control an overlapping-gate charge-coupled device.

According to one aspect of the invention, a nanofabric switch is used as an element in or to control a p-channel charge-coupled device.

According to one aspect of the invention, a nanofabric switch is used as an element in or to control a peristaltic charge-coupled device.

According to one aspect of the invention, a nanofabric switch is used as an element in or to control a Schottky-barrier charge-coupled device.

According to one aspect of the invention, a nanofabric switch is used as an element in or to control a surface-channel charge-coupled device (SCCD).

According to one aspect of the invention, a nanofabric switch is used as an element in or to control a two-phase charge-coupled device.

According to one aspect of the invention, a nanofabric switch is used as an element in or to control a floating gate.

According to one aspect of the invention, a nanofabric switch is used as an element in or to control a three-state bus.

According to one aspect of the invention, a nanofabric switch is used as an element in or to control a rectifier diode.

According to one aspect of the invention, a nanofabric switch is used as an element in or to control a thyristor.

According to one aspect of the invention, a nanofabric switch is used as an element in or to control low-voltage emitter-coupled logic (ECL) integrated circuits.

According to one aspect of the invention, a nanofabric switch is used as an element in or to control DDR-II SDRAMs.

According to one aspect of the invention, a nanofabric switch is used as an element in or to control LVTTL-compatible and LVCMOS-compatible circuits.

According to one aspect of the invention, a nanofabric switch is used as an element in or to control semiconductor power control modules (SPCMs).

According to one aspect of the invention, a nanofabric switch is used as an element in or to control fast CMOS TTL compatible logic as well as logic using other voltage standards.

According to one aspect of the invention, a nanofabric switch is used as an element in or to control 54/74ABTXXX and TTL-Compatible BiCMOS logic devices.

According to one aspect of the invention, a nanofabric switch is used as an element in or to control low-voltage TTL-compatible BiCMOS logic devices.

According to one aspect of the invention, a nanofabric switch is used as an element in or to control 2.5 volt CMOS logic devices, including those with 3.6 volt or 5 volt CMOS tolerant inputs and outputs.

According to one aspect of the invention, a nanofabric switch is used as an element in or to control thyristor surge protective devices.

According to one aspect of the invention, a nanofabric switch is used as an element in or to control 3.3 volt NFET bus switch devices, including those with integrated charge pumps.

According to one aspect of the invention, a nanofabric switch is used as an element in or to control 2.5 volt single 10 bit, 2-port DDR FET switches.

According to one aspect of the invention, a nanofabric switch is used as an element in or to control 2.5 volt dual 5 bit, 2-port DDR FET switches.

According to one aspect of the invention, a nanofabric switch is used as an element in or to control 1.8 volt CMOS logic devices, and those logic devices using other voltages, including but not limited to 1.2 volt (of both wide and normal range operation), 1.5 and 2.5 volt.

According to one aspect of the invention, a nanofabric switch is used as an element in or to control semiconductor and optoelectronic devices.

According to one aspect of the invention, a nanofabric switch is used as an element in or to control multiport DRAM (MPDRAM) or video ram.

According to one aspect of the invention, a nanofabric switch is used as an element in or to control electrically erasable programmable ROM (EEPROM).

According to one aspect of the invention, a nanofabric switch is used as an element in or to control liquid crystal devices.

According to one aspect of the invention, a nanofabric switch is used as an element in or to control bipolar transistors, including insulated gate bipolar transistors.

According to one aspect of the invention, a nanofabric switch is used as an element in or to control bridge rectifier assemblies.

According to one aspect of the invention, a nanofabric switch is used as an element in or to control 3.3 V, 18-bit, LVTTL I/O register for PC133 registered DIMM applications.

According to one aspect of the invention, a nanofabric switch is used as an element in or to control SSTV16857 2.5 V, 14-bit SSTL_{—}2 registered buffer for DDR DIMM applications.

According to one aspect of the invention, a nanofabric switch is used as an element in or to control SSTV16859 2.5 V, 13-bit to 26-bit SSTL_{—}2 registered buffer for stacked DDR DIMM applications.

According to one aspect of the invention, a nanofabric switch is used as an element in or to control A 3.3 V, zero delay clock distribution device compliant with the JESD21-C PC133 registered DIMM specification.

According to one aspect of the invention, a nanofabric switch is used as an element in or to control SSTV32852 2.5-V 24-bit to 48-bit SSTL_{—}2 registered buffer for 1U stacked DDR DIMM applications.

According to one aspect of the invention, a nanofabric switch is used as an element in or to control SSTU32864 1.8-V configurable registered buffer for DDRII RDIMM applications.

According to one aspect of the invention, a nanofabric switch is used as an element in or to control silicon rectifier diodes.

According to one aspect of the invention, a nanofabric switch is used as an element in or to control small signal and rectifier diodes.

According to one aspect of the invention, a nanofabric switch is used as an element in or to control devices in military applications.

According to one aspect of the invention, a nanofabric switch is used as an element in or to control electronic elements in a medical device.

According to one aspect of the invention, a nanofabric switch is used as an element in or to control elements in consumer goods.

According to one aspect of the invention, a nanofabric switch is used as an element in or to control elements in global positioning satellite compatible devices.

According to one aspect of the invention a nanofabric switch can be embedded within a process flow using bipolar-and-CMOS (BiCMOS) technology or to control a device constructed using bipolar-and-CMOS (BiCMOS) technology process flow.

According to one aspect of the invention a nanofabric switch can be embedded within a process flow using bipolar-and-CMOS-and-DMOS (BCD) technology or to control a device constructed using bipolar-and-CMOS-and-DMOS (BCD) technology process flow.

According to one aspect of the invention a nanofabric switch can be embedded within a process flow using bipolar-and-FET (BiFET) technology or to control a device constructed using bipolar-and-FET (BiFET) technology process flow.

According to one aspect of the invention a nanofabric switch can be embedded within a process flow using or bipolar-and-MOS (BiMOS) technology to control a device constructed using bipolar-and-MOS (BiMOS) technology process flow.

According to one aspect of the invention a nanofabric switch can be embedded within a process flow using bipolar technology or to control a device constructed using bipolar technology process flow.

According to one aspect of the invention a nanofabric switch can be embedded within a process flow using CMOS-and-DMOS(C/DMOS) technology or to control a device constructed using CMOS-and-DMOS(C/DMOS) technology process flow.

According to one aspect of the invention a nanofabric switch can be embedded within a process flow using complementary integrated circuit technology or to control a device constructed using complementary integrated circuit technology process flow.

According to one aspect of the invention a nanofabric switch can be embedded within a process flow using complementary metal-oxide semiconductor (CMOS) technology or to control a device constructed using complementary metal-oxide semiconductor (CMOS) technology process flow.

According to one aspect of the invention a nanofabric switch can be embedded within a process flow using double-diffused MOS (DMOS) technology or to control a device constructed using double-diffused MOS (DMOS) technology process flow.

According to one aspect of the invention a nanofabric switch can be embedded within a process flow using metal-insulator-semiconductor (MIS) technology or to control a device constructed using metal-insulator-semiconductor (MIS) technology process flow.

According to one aspect of the invention a nanofabric switch can be embedded within a process flow using metal-nitride-oxide-semiconductor (MNOS) technology or to control a device constructed using metal-nitride-oxide-semiconductor (MNOS) technology process flow.

According to one aspect of the invention a nanofabric switch can be embedded within a process flow using silicon-gate-insulator-semiconductor (SIS) technology or to control a device constructed using silicon-gate-insulator-semiconductor (SIS) technology process flow.

According to one aspect of the invention a nanofabric switch can be embedded within a process flow using silicon-nitride-oxide-semiconductor (SNOS) technology or to control a device constructed using silicon-nitride-oxide-semiconductor (SNOS) technology process flow.

According to one aspect of the invention a nanofabric switch can be embedded within a process flow using silicon-on-sapphire (SOS) technology or to control a device constructed using silicon-on-sapphire (SOS) technology process flow.

According to one aspect of the invention a nanofabric switch can be embedded within a process flow using silicon-oxide-nitride-oxide-semiconductor (SONOS) technology or to control a device constructed using silicon-oxide-nitride-oxide-semiconductor (SONOS) technology process flow.

### BRIEF DESCRIPTION OF THE DRAWINGS

In the drawing,

FIGS. 1-4 illustrate vertically oriented nanoswitches;

FIG. 5 illustrates a compound nanoswitch;

FIGS. 6-10 illustrate compound nanoswitches and exemplary metallization schemes;

FIG. 11 illustrates exemplary horizontally-oriented nanoswitches;

FIG. 12 illustrates an exemplary horizontally oriented nanoswitch in a deflected state;

FIG. 13(A) illustrates a plan view of intermediate structure 1300, said view showing where cross sections of subsequent figures are taken; and

FIGS. 13(B)-13(D) are perspective views of intermediate structure 1350 showing cross sections of that figure at different locations.

### DETAILED DESCRIPTION

A nanofabric or ribbon has been shown to substantially conform to a surface, such as a surface of an article on a semiconductor substrate. The present inventors have appreciated that devices such as electromechanical switches can be constructed using nanofabrics which have conformed to a surface which is substantially perpendicular to a semiconductor substrate (vertically-oriented) and that such devices can be used as vertically oriented switches in a plethora of applications. Fabrication techniques to develop such vertically-disposed devices are described in U.S. Pat. Apl. Ser. No. 60/446,786 and include the ability to form said switches for use in many different articles having relatively short spans of suspended nanofabric articles. In some embodiments, this allows smaller device dimensions and higher strains in the nanofabric articles, as well as lower electrical resistances.

Horizontally oriented nanofabric switches may also be used in a plethora of applications and their fabrication is described in U.S. Pat. Apl. Ser. No. 60/446,783. The inventors appreciate that because nanofabrics conform to substrate surfaces, switches oriented between horizontal and vertical may be made, (i.e. diagonally oriented switches).

As more fully described in incorporated references (U.S. Ser. Nos. 09/915,093, 09/915,173, 09/915,095, 10/033,323, 10/033,032, 10/128,118, 10/128,117, 10/341,005, 10/341,055, 10/341,054, 10/341,130, 60/446,783, 60/446,786 and 60/476,976), a fabric is created upon a substrate or surface, the surface comprising rigid supports and a sacrificial layer. The sacrificial layer is removed, leaving nanofabric suspended from the supports and not in contact with material in the space where the sacrificial layer had been. Generally, an electrode is situated such that the nanofabric may deflect from a resting suspended position into a conformation whereby part of the nanofabric contacts the electrode, while remaining in contact with the supports. Volatile and non-volatile switches, and switching elements of numerous types of devices, can be thus created. In certain preferred embodiments, the articles include substantially a monolayer of carbon nanotubes.

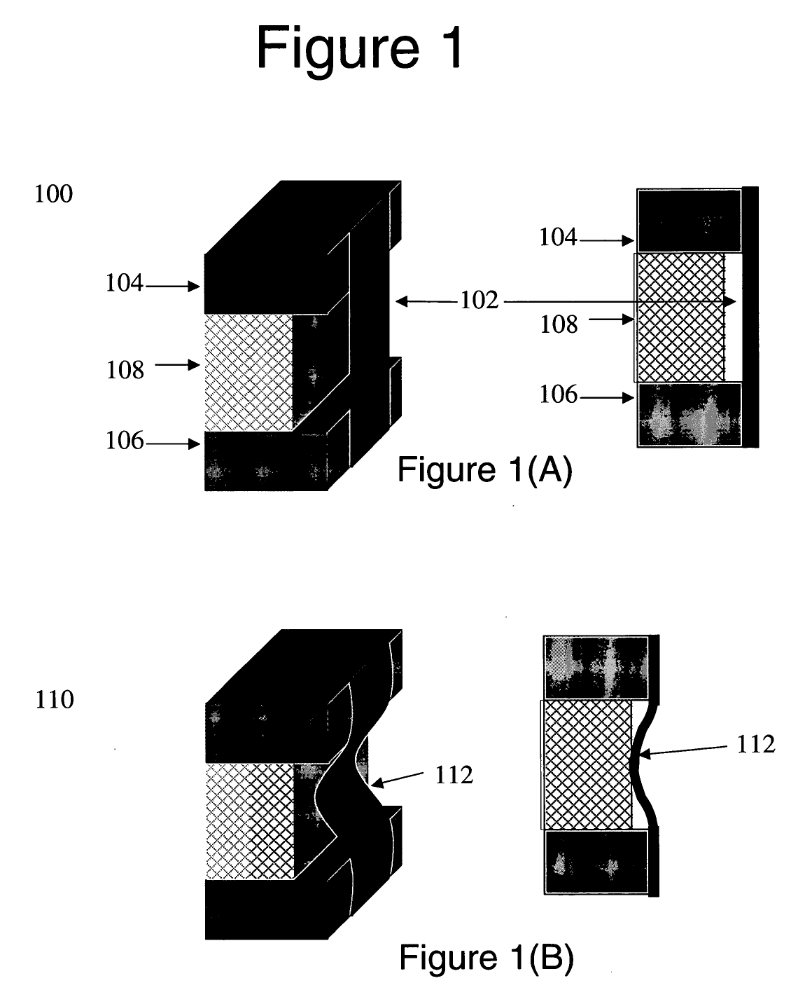

FIGS. 1(A)-(B) are perspective and cross-sectional views of an exemplary electromechanical switch. Structure 100 (FIG. 1(A)) depicts an “on” state and structure 110 (FIG. 1(B)) depicts an “off” state. The designations “on” and “off” are in some sense arbitrary and this notation may be reversed with no loss of generality. In this embodiment, the structure contains nanofabric article 102 spanning between an upper insulating support structure 104 and a lower insulating support structure 106. Disposed between upper and lower insulating support structures 104 and 106 is an electrode 108. FIG. 1(A) illustrates a deflected nanofabric article 112. The article may be volatilely or non-volatilely switched depending on the physical characteristics of the system, as described below and in incorporated references. Deflected nanofabric article 112 is shown to be in contact with electrode 108.

Note that reference to a nanofabric, such as nanofabric article 102, is generally meant to include any suitable structure or article comprising nanotubes, and specifically includes ribbons and nanofabric electrodes containing nanotubes.

Under certain preferred embodiments, a nanofabric article 102 has a width (W) of about 180 nm or smaller and is pinned to insulating support structures 104 and 106. Pinning of nanofabric articles is described here and elsewhere in the incorporated references in more detail. The electrode 108 may be made of any suitable electrically conductive material and may be arranged in any of a variety of suitable geometries. Certain preferred embodiments utilize n-doped silicon to form such a conductive element which can be, preferably no wider than the nanofabric article 102, e.g., about 180 nm or below. Other embodiments utilize metal as conductor. In certain embodiments the electrode 108 can be constructed from a nanofabric as well.

The material of the insulating support structures 104 and 106, likewise, may be made of a variety of materials and into various geometries, but certain preferred embodiments utilize insulating material, such as spin-on-glass (SOG) or silicon nitride or silicon oxide.

As will be explained below, in certain embodiments, the nanofabric article 102 is held to the insulating support structures by friction. In other embodiments, the nanofabric article 102 may be held by other means, such as by anchoring the nanofabric to the insulating support structures using any of a variety of techniques.

Specifically, the nanofabric article 102 may be coupled to another material by introducing a matrix material into the spaces between nanotubes in a porous nanofabric to form a conducting composite junction, as described in the references incorporated above. Electrical and mechanical advantages may be obtained by using such composite junctions and connections. In one example, a conducting material is deposited onto the nanofabric and is allowed to penetrate into the spaces within the porous nanofabric, thus forming an improved electrical connection to the nanofabric and reduces contact resistance in the article. In another example, an insulating material is deposited onto the nanofabric and is allowed to penetrate into the spaces within the porous nanofabric, thus forming an improved mechanical pinning contact that increases strain in the article.

Evaporated or spin-coated material such as metals, semiconductors or insulators—especially silicon, titanium, silicon oxide or polyamide—may be used to increase the pinning strength. The friction interaction can be increased through the use of chemical interactions, including covalent bonding through the use of carbon compounds such as pyrenes or other chemically reactive species. See R. J. Chen et al., “Noncovalent Sidewall Functionalization of Single-Walled Carbon Nanotubes for Protein Immobilization,” J. Am. Chem. Soc., vol. 123, pp. 3838-39 (2001), and Zhang et al., “Formation of metal nanowires on suspended single-walled carbon Nanotubes”, Appl. Phys. Lett., vol. 77, pp. 3015-17 (2000), for exemplary techniques for pinning and coating nanotubes by metals. See also WO 01/03208 for techniques. It should be noted that the effect of the van der Waals interaction between nanofabrics and other elements can be affected at their interface(s). The effect may be enhanced or diminished: e.g. the attractive force can be diminished by coating the surface of the electrode with a thin layer of oxide other suitable chemical(s). The purpose of diminishing the attractive forces may be to create volatile nanoswitches which may be especially useful in applications such as relays, sensors, transistors, resonators, etc.

In some embodiments, where a nanofabric article 102 crosses a corresponding, oppositely-disposed electrode defines a memory or logic cell, switch or relay. More than one such crossing can be used in arrays or as individual or small groups of interconnected switches depending upon the application such as an element in or an element used to control; devices in military applications, embedded memory, a two-chip memory device, a relays, an actuators, an active device, an application-specific integrated circuit (ASIC), a logic array (uncommitted logic array), an asynchronous circuit, a charge pump, a circuit element, an active circuit element, a parasitic circuit element, a passive circuit element, as an element in or to control an electrical connection (within a semiconductor device), a semiconductor diode, a discrete (semiconductor) device, e.g. a diode, a transistor, a rectifier, a thyristor, or multiple versions of these devices, e.g. complex Darlington transistors, an element in or to control a logic gate; a combinational logic function consisting of a number of inputs and outputs and performing one of the Boolean functions AN devices in military applications, AND, OR, exclusive OR, NAND, NOR, or exclusive NOR (note: for the purpose of specifying complexity, (1) buffers and inverters are counted as gates and (2) exclusive OR and exclusive NOR gates, some high-input-count gates, and memory functions are counted as multiple gates), a Schmitt trigger, a collector field-effect transistor, a source, whose gate is connected to the substrate, a field-effect transistor (FET), a insulated-gate field-effect transistor (IGFET), a junction-gate field-effect transistor (JFET), a lateral transistor, a metal-oxide-semiconductor field-effect transistor (MOSFET), a substrate pnp transistor, a unipolar transistor, a via, a cell compiler, a logic interconnection, a channelless gate array, an element in or to control a field-programmable gate array, a field-programmable logic array (FPLA), a field-programmable logic sequencer (FPLS), a gate array integrated circuit, a hardware accelerator, a macrocell, a primitive, i.e. a basic building block for a specified level of design hierarchy. a process-programmable gate array, a programmable logic array (PLA), a programmable logic sequencer (PLS), a silicon compiler, a sink driver, (current-), a source driver, (current-), (bipolar) output(s), a three-state output, a unipolar output, a balanced amplifier, differential inputs, differential outputs, an analog-to-digital [A/D] converter (ADC), an analog gate, a buffer, a bus driver, a bus receiver, a clock driver, a differential voltage comparator, a decoder, a differential line receiver, a differential video amplifier, a digital-to-analog [D/A] converter (DAC), a driver, an encoder, an interface integrated circuit, a line driver, a line receiver, a logic-level converter/logic-level translator, a peripheral driver, a memory sense amplifier, a sink LED decoder driver, a source LED decoder driver, a universal asynchronous receiver transmitter (UART), an element in or to control a video amplifier, an analog-to-digital processor, a series control element (series pass element), a bucket-brigade device (BBD), a bulk-channel charge-coupled device (BCCD), a buried-channel charge-coupled device (BCCD), a charge-coupled device (CCD), a charge-coupled image sensor, a charge-transfer device (CTD), a conductivity-connected charge-coupled device (C4D), a junction-gate charge-coupled device, an n-channel charge-coupled device, a overlapping-gate charge-coupled device, a p-channel charge-coupled device, a peristaltic charge-coupled device, a Schottky-barrier charge-coupled device, a surface-channel charge-coupled device (SCCD), a two-phase charge-coupled device, a floating gate, a three-state bus, a rectifier diode, low-voltage emitter-coupled logic (ECL) integrated circuits, DDR-II SDRAMs, LVTTL-compatible and LVCMOS-compatible circuits, semiconductor power control modules (SPCMs), fast CMOS TTL compatible logic as well as logic using other voltage standards, 54/74ABTXXX and TTL-Compatible BiCMOS logic devices, low-voltage TTL-compatible BiCMOS logic devices, 2.5 volt CMOS logic devices, including those with 3.6 volt or 5 volt CMOS tolerant inputs and outputs, thyristor surge protective devices, 3.3 volt NFET bus switch devices, including those with integrated charge pumps, 2.5 volt single 10 bit, 2-port DDR FET switches, 2.5 volt dual 5 bit, 2-port DDR FET switches, 1.8 volt CMOS logic devices, and those logic devices using other voltages, including but not limited to 1.2 volt (of both wide and normal range operation), 1.5 and 2.5 volt, semiconductor and optoelectronic devices, multiport DRAM (MPDRAM) or video ram, electrically erasable programmable ROM (EEPROM), liquid crystal devices, bipolar transistors, including insulated gate bipolar transistors, bridge rectifier assemblies, 3.3 V, 18-bit, LVTTL I/O register for PC133 registered DIMM applications, SSTV16857 2.5 V, 14-bit SSTL_{—}2 registered buffer for DDR DIMM applications, SSTV16859 2.5 V, 13-bit to 26-bit SSTL_{—}2 registered buffer for stacked DDR DIMM applications, A 3.3 V, zero delay clock distribution device compliant with the JESD21-C PC133 registered DIMM specification, SSTV32852 2.5-V 24-bit to 48-bit SSTL_{—}2 registered buffer for 1U stacked DDR DIMM applications, SSTU32864 1.8-V configurable registered buffer for DDRII RDIMM applications, silicon rectifier diodes, small signal and rectifier diodes, elements in a medical device, elements in consumer goods, elements in global positioning satellite compatible devices, a device constructed with a bipolar-and-CMOS (BiCMOS) technology process flow, a device constructed with bipolar-and-CMOS-and-DMOS (BCD) technology process flow. The nanofabric switch can be embedded within a process flow using or to control: a device constructed with bipolar-and-FET (BiFET) technology process flow, a device constructed with bipolar-and-MOS (BiMOS) technology process flow, a device constructed with bipolar technology process flow, a device constructed with CMOS-and-DMOS(C/DMOS) technology process flow, a device constructed with complementary integrated circuit technology process flow, a device constructed with complementary metal-oxide semiconductor (CMOS) technology process flow, a device constructed with double-diffused MOS (DMOS) technology process flow, a device constructed with metal-insulator-semiconductor (MIS) technology process flow, a device constructed with metal-nitride-oxide-semiconductor (MNOS) technology process flow, a device constructed with silicon-gate-insulator-semiconductor (SIS) technology process flow, a device constructed with process flow, a device constructed with silicon-nitride-oxide-semiconductor (SNOS) technology process flow, a device constructed with silicon-on-sapphire (SOS) technology process flow, or a device constructed with silicon-oxide-nitride-oxide-semiconductor (SONOS) technology process flow. The actual number of such cells is immaterial to understanding the invention, but the technology may support devices having information storage capacities at least on the order of modern nonvolatile circuit devices.

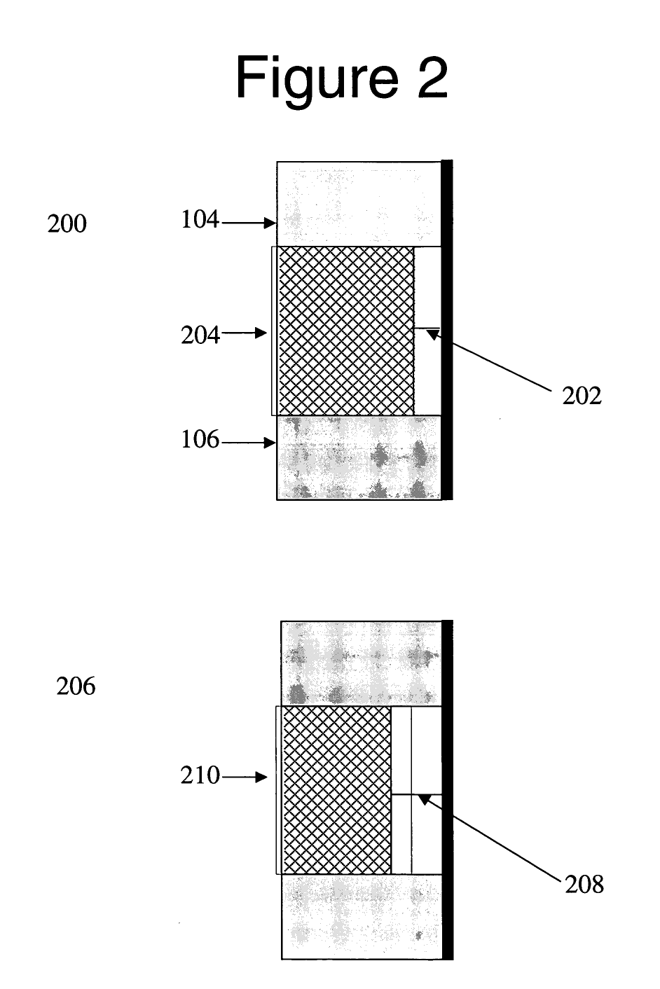

FIGS. 2-4 are cross-sectional diagrams of individual nanoswitches illustrating various states of the device.

FIG. 2 illustrates nanoswitches with different gap distances 202 and 208 between nanofabric article 102 and electrodes 204 and 210, shown in structures 200 and 206, respectively. In certain embodiments, the vertical spacing between the insulating support structures 104 and 106 is about 180 nm. The relative separation, i.e. gap distance 202, from the top of insulating support structure 104 to the deflected position where the nanofabric article 102 contacts electrode 204, should be approximately 5-50 nm. The magnitude of the gap distance 202 is designed to be compatible with electromechanical switching capabilities of the specific application. The 5-50 nm gap distance is preferred for certain embodiments utilizing nanofabrics 102 made from carbon nanotubes, and reflects the specific interplay between strain energy and adhesion energy for the deflected nanotubes. Other gap distances may be preferable for other materials. Switching between “on” and “off” states is accomplished by the application of specific voltages across the nanofabric article 102 and one or more of its associated electrodes, e.g. 204, 210, or other release electrode. Switching forces are based on the interplay of electrostatic attraction and repulsion between the nanofabric article 102 and the electrodes, e.g. 204, 210.

By selecting a gap distance 202 in which the strain energy is lower than the adhesion energy, the nanofabric article 102 can remain in permanent “non-volatile” contact with the electrode 204. If a larger gap distance 208 were selected, the strain energy increases to such an extent as to allow the nanofabric article 102 to contact the electrode 210 but not to remain in such contact without additional power input, defining a “volatile” condition. In some embodiments, such a volatile switch is preferred and can be combined with non-volatile switches as is necessary for use in particular devices.

The dimensions given above are exemplary and non-limiting, and can be greater or smaller in some embodiments, depending on the application and materials and techniques used. The length of the nanofabric article 102 in vertically-disposed articles can be quite short in comparison to other types of nanofabric articles, e.g. horizontally-disposed nanofabric switches. In some cases, thin film techniques, such as thin film deposition or etching can be used rather than using lithographic techniques to form the electrodes and gaps spanned by the suspended nanofabric ribbons. This is much shorter than the length of the nanofabrics used in horizontally disposed devices, such as those described below and in the incorporated reference entitled “Electro-Mechanical Switches and Memory Cells Using Horizontally-Disposed Nanofabric Articles and Methods of Making the Same.”

A short span of nanofabric can lead to increased strain in the article. Also, shorter spans of nanofabric result in reduced electrical resistance to current flowing through the nanofabric. Further embodiments, below, illustrate other types of vertically-disposed articles, and methods of manufacturing the same.

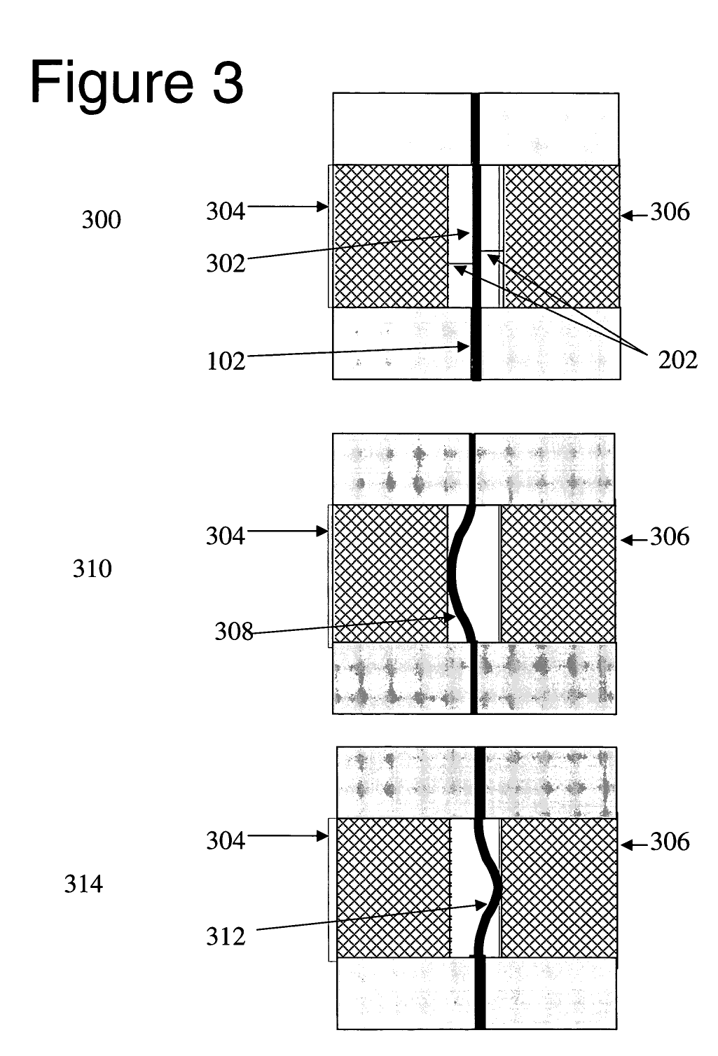

FIG. 3 illustrates some possible “on” and “off” states of certain embodiments of the invention. When the device is as illustrated by structure 300, the nanofabric article 302 is separated from both electrodes 304 and 306 by a distance 202. This state may be electrically detected in any of a variety of ways described in the foregoing references incorporated by reference. In this arrangement, an “off” state corresponds to nanofabric-electrode junction being an open circuit, which may be sensed as such on either the nanofabric article 102 or electrode 304 when addressed. When the cell is as shown by structure 310, the nanofabric article 308 is deflected toward electrode 304. In certain embodiments the “on” states corresponding to the nanofabric-electrode junction is an electrically conducting, rectifying junction (e.g., Schottky or PN), which may be sensed as such on either the nanofabric article 308 or electrode 306 when addressed. When the cell is as shown by structure 314, the nanofabric article 312 is deflected toward electrode 306 generating an “on” state. The figures are not drawn to scale, and the distances 202, for example, need not be equal. As was noted earlier, the designation “on” and “off” are somewhat arbitrary, and nanofabric contact with electrode may be considered “on” or “off” without loss of understanding of the invention.

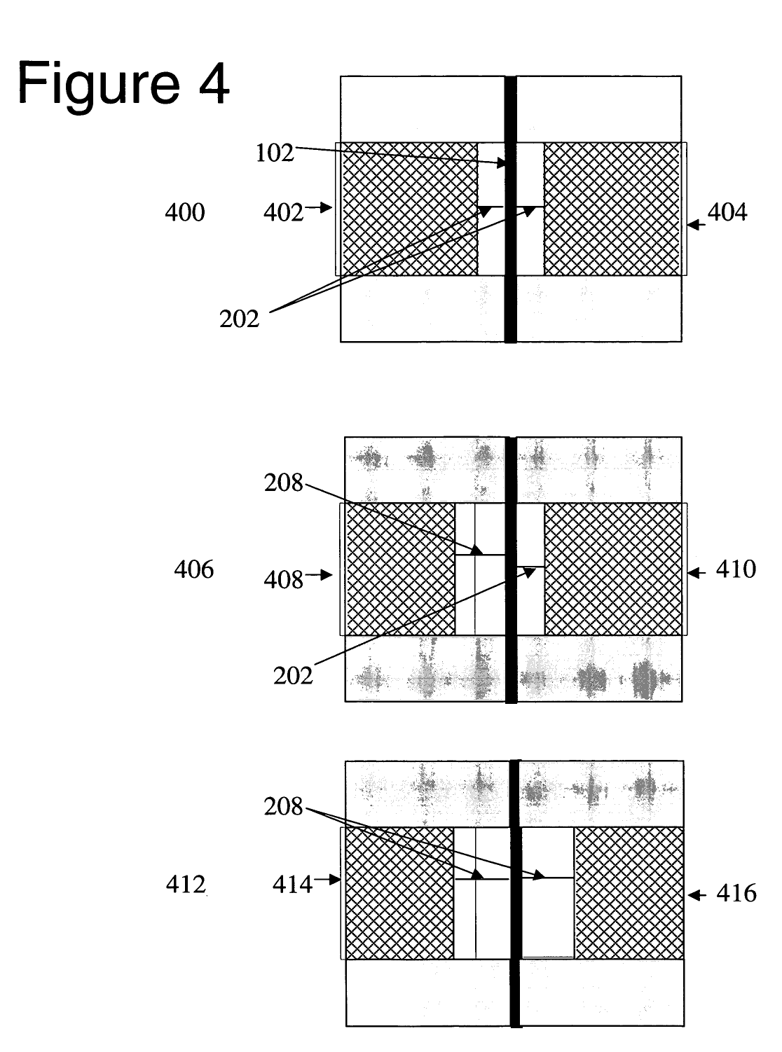

FIG. 4 illustrates some other possible tristate device configurations. A first tristate device 400 has two non-volatile “on” states. The distance 202 between the non-deflected nanofabric article 102 and either electrode 402 or 404 is small enough that upon deflection the nanofabric non-volatilely contacts either electrode 402 or 404. Under this embodiment a stable van der Waals interaction is formed yielding a non-volatile condition in which the deflected nanofabric article 102 contacts either electrode, closing a circuit and remaining in contact with the electrode indefinitely without the need for additional power.

A second tristate device 406 allows for nanofabric deflection to be either non-volatile or volatile. If the nanofabric article 102 deflects toward electrode 410, then the distance 202 is small enough to allow for a nonvolatile state as above. If, however the nanofabric article 102 is deflected toward electrode 408, then the gap distance 208, between the nanofabric article 102 and the contacted electrode 408 has been increased such that the strain energy of the stretched nanofabric article 102 overcomes the van der Waals attraction between the nanofabric article 102 and the electrode 408; the nanofabric article 102 briefly forms part of a closed circuit generating a transient “on” state and returns to its non-deflected, open circuit state generating an “off” state.

Structure 412 illustrates yet a third tristate device where the gap distances 208 between the nanofabric article 102 and the electrodes 414 and 416 are large enough to form volatile nanoswitches as described above.

In certain embodiments involving a non-volatile cell, there is a high ratio between resistances in the “off” and the two “on” states. The differences between resistances in the “off” and “on” states provides a means to read which state a junction is in. In one approach, a “readout current” is applied to the nanofabric or electrode and the voltage across the junction is determined with a “sense amplifier” on the electrodes. Reads are non-destructive, meaning that the cell retains its state, and no write-back operations are needed as is required with semiconductor DRAMs. As alluded to above, the three-trace junctions of preferred embodiments bring their own advantages. By allowing for use of tristate memory cells, more information may be stored or represented by a given cell. Moreover, even if only one of the “on” states were used, three-trace junctions may increase switching speeds from the ability to use both conductive traces in concert to apply forces to move an electromechanically responsive nanofabric 102. The inventors contemplate that a tristate switching device may be used in other primitives besides memory devices. The switches are useful as elements in chips and elements in packages as well.

Furthermore, advantages in increased reliability and defect tolerance can come from the redundancy permitted, by the presence of two conductive electrodes in each cell. Each of the two conductive electrodes may be separately used to apply forces to move an electromechanically responsive nanofabric, and each of the two conductive electrodes may serve as the “contact” for one of two alternative “on” states. Thus, the failure of one conductive trace may not be fatal to junction performance. Among other things the structures as shown in FIGS. 3 and 4 (generally) facilitate packaging and distribution, and allow the nanotube-technology cells to be more easily incorporated into other circuits and systems such as hybrid circuits. The nature and electrical architecture of the vertically oriented nanofabric switches can also facilitate the production of stackable memory layers and the simplification of various interconnects.

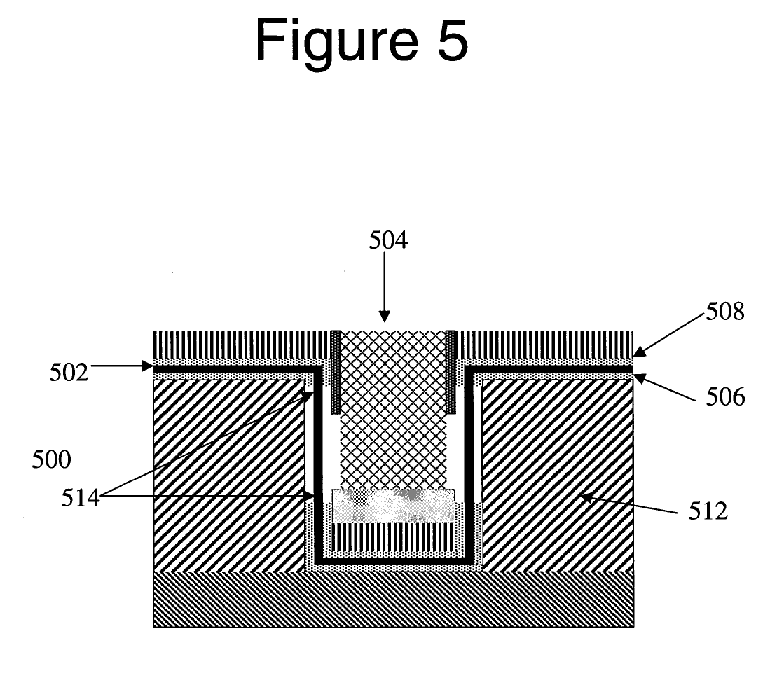

FIG. 5 illustrates an exemplary article incorporating nanotube switches. The fabrication of this element in described more fully in incorporated reference, U.S. patent application Ser. No. 60/446,786.

Structure 500 includes the following elements; nanofabric ribbons 502, disposed adjacent to electrode 504 and spaced by insulating first spacer material 506 and second spacer material 508. Side material 512 may be insulating or conducting depending on application. If side material 512 is not insulated, then interconnects (not shown) would be incorporated in to the structure as descried in incorporated reference U.S. patent application Ser. No. 60/446,786 furthermore, one skilled in the art would understand how to provide such structure(s).

In these and other embodiments, the nature of the resulting devices and switches depends on the construction and arrangement of the electrodes and connections, among other factors. Attention is called to the construction of various types of electrodes in the following embodiments, as an indication of the flexibility of these devices and the variety of their potential uses. For example, some devices share common electrodes between more than one nanofabric article (e.g. two nanofabric switch elements being influenced by a same shared electrode). Other devices have separate electrodes that control the behavior of the nanofabric. One or more electrodes can be used with each nanofabric article to control the article, as mentioned in the incorporated reference entitled “Electromechanical Three-Trace Junction Devices,” U.S. patent application Ser. No. 10/033,323.

If vertical height 514 is 200 nm and first insulating layer 506 and second insulating layer 508 are increased to a thickness of about 50 nm the nanotube switch would become volatile because the deflected nanofabric has a strain energy higher than that of the van der Waals force keeping the fabric in contact with side layer 512 or electrode 504. The thicknesses of first insulating layer 506 and second insulating layer 508 can be adjusted to generate either a non-volatile or volatile condition for a given vertical gap 514 as called for by particular applications with desired electrical characteristics.

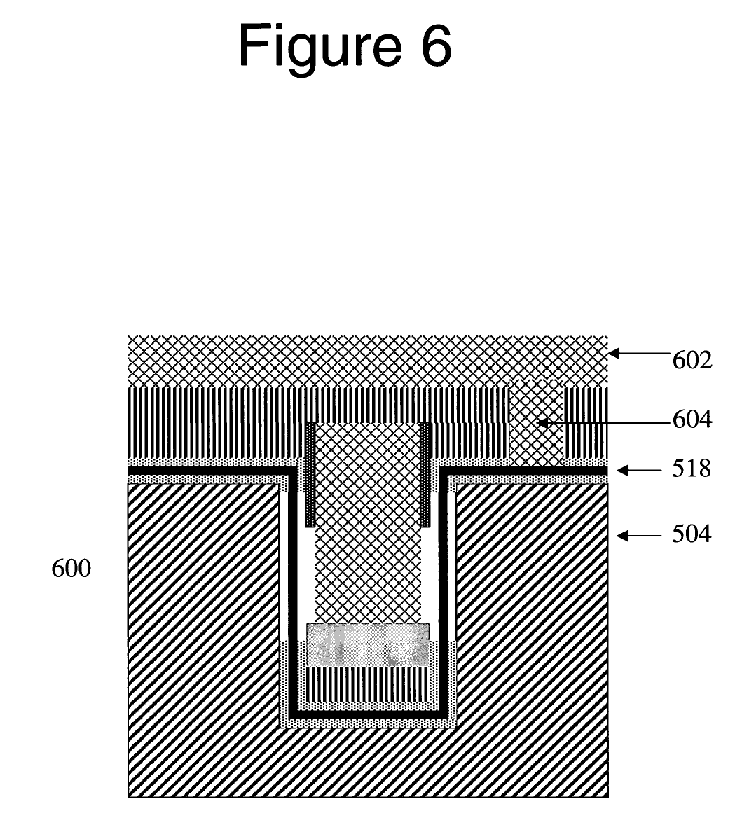

FIG. 6 illustrates an exemplary structure with subsequent layers of metallization. This structure includes electrode interconnect 602 and via 604 in contact with nanofabric 502 and a contiguous side layer 512 surrounding the electromechanical switch both laterally and subjacently, as shown in structure 600.

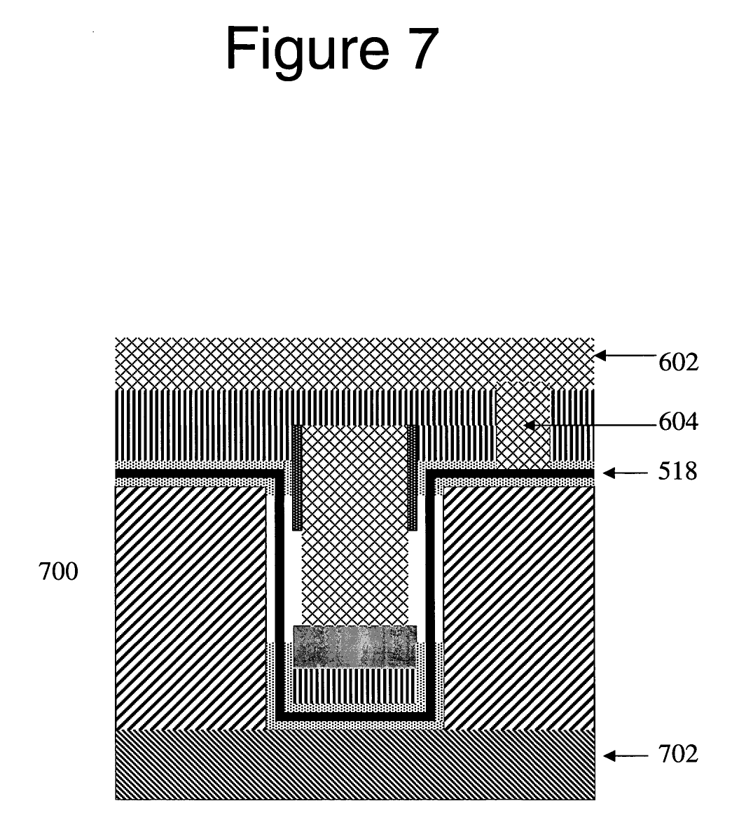

FIG. 7 illustrates an exemplary structure with subsequent layers of metallization. This structure is similar to intermediate structure 600 in several respects. However, an insulating layer 702 separates the portions of side layer 512, and therefore side layer 512 does not surround the electromechanical switch elements, preventing crosstalk as shown in intermediate structure 600.

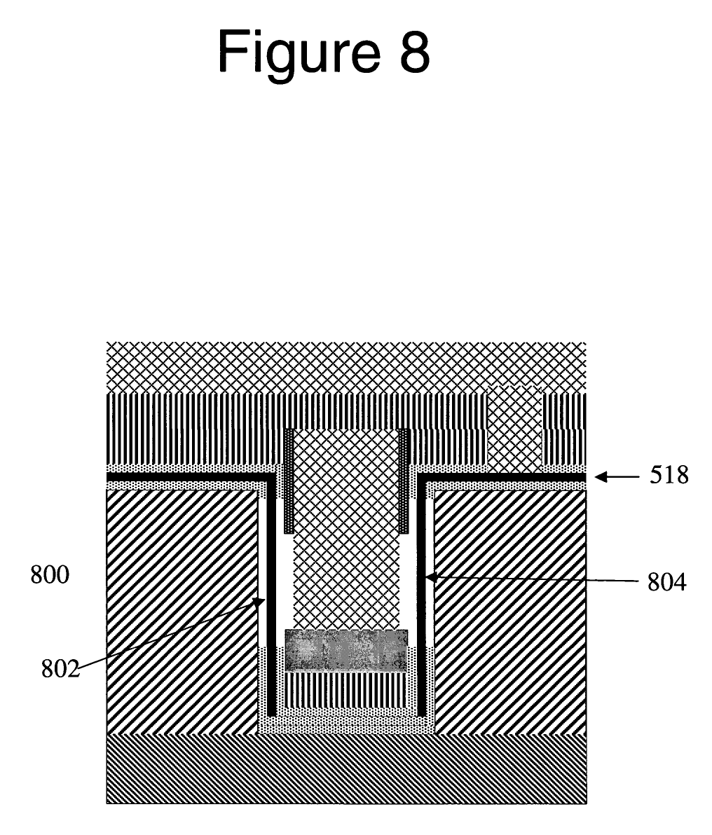

FIG. 8 illustrates an exemplary structure with subsequent layers of metallization. This structure is similar to intermediate structure 700, however, the nanofabric layer 502 is not continuous, and therefore there are 2 independent switches 802, 804, which have no crosstalk, as shown in intermediate structure 800.

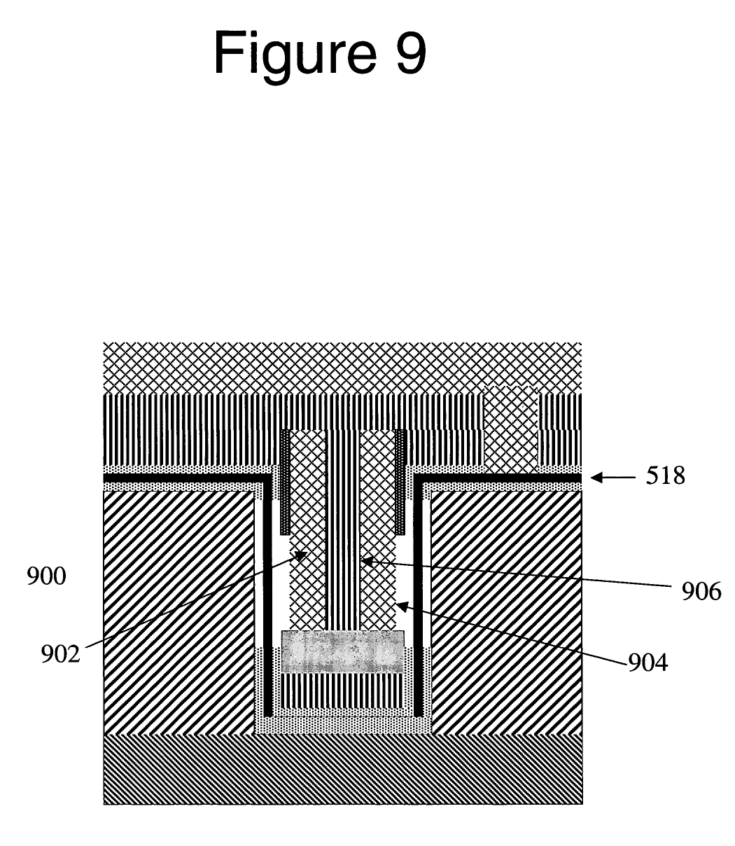

FIG. 9 is an exemplary structure with subsequent layers of metallization. This structure is similar to intermediate structure 800, however, instead of a single central electrode, there are two central electrodes, 902, 904 separated by insulating layer 906. Intermediate structure 900 has two nano-electromechanical switches, which can be operated independently.

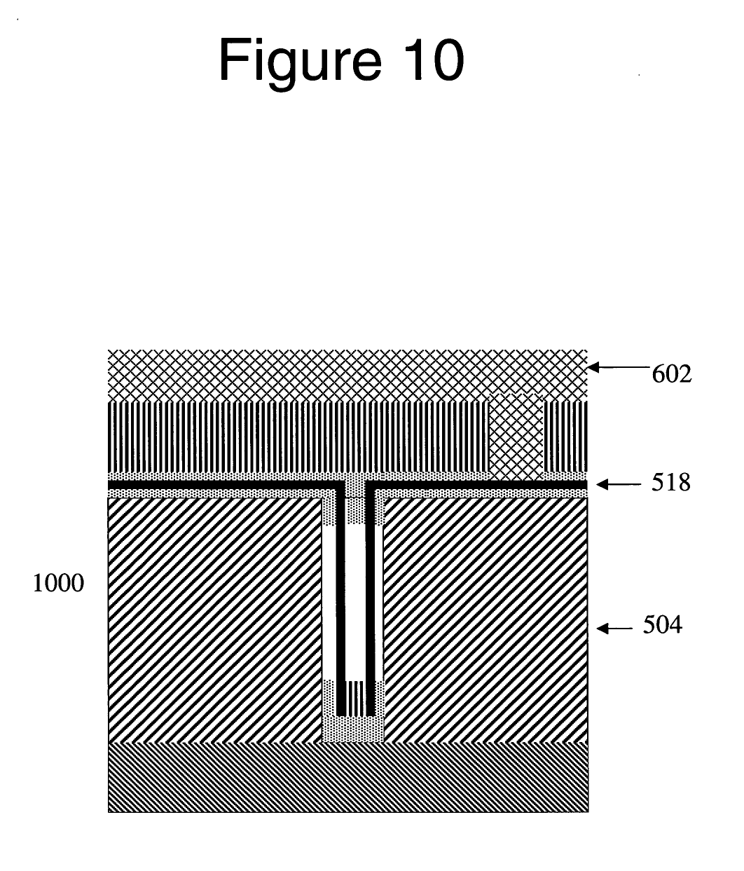

FIG. 10 is an exemplary structure with subsequent layers of metallization. This structure is similar to intermediate structures 800 and 900, except there is no central electrode, at all. In this embodiment, it is possible for the nanofabric switches to contact side layers 512 to make a volatile or non-volatile switch, and it is possible for the switches to contact one another so as to be volatile or non-volatile.

The devices and articles shown in the preceding embodiments are given for illustrative purposes only, and other techniques may be used to produce the same or equivalents thereof. Furthermore, the articles shown may be substituted with other types of materials and geometries in yet other embodiments. For example, rather than using metallic electrodes, some embodiments of the present invention may employ nanotubes. In fact, devices comprising nanotube and nanofabric articles in place of the electrodes shown above can be constructed as well.

Additional electrodes can provide extra control of a switch or device constructed according to the present description. For example, FIG. 6 includes two distinct electrodes that will push and/or pull the vertical nanofabric sections in unison. The gap distances will determine whether the devices are volatile or nonvolatile for a given set of parameters.

FIG. 7 includes 3 distinct electrodes and gives extra degrees of freedom (extra redundancy, extra information storage capability, etc.) to the devices. FIG. 8 also includes 3 electrodes.

FIG. 9 includes 4 distinct electrodes, since the center electrode is divided into two electrodes (902, 904) by application of divider 906.

FIG. 10 includes two electrodes on the sides of the channel, and uses a nanofabric section coupled to top electrode 602 as a third electrode in structure 1000.

As mentioned previously, using vertically-disposed nanofabric articles permits exploitation of the smaller dimensions achievable with thin film technology than with the lithographic techniques used in horizontally-disposed nanofabric articles. For example, returning to FIG. 1(A), the dimension T, or thickness of the electrode 108, across which the nanofabric is suspended is as little as a few nm thick (e.g. 10-100 nm), and is formed using thin film techniques. As technology develops in this regard, the thickness T can be less than 10 nm thick. Therefore, the scaling of the dimensions tracks with thin film technology rather than scaling with lithographic technology. It should be noted that the gap distances used with reduced length nanofabric articles may also be decreased accordingly.

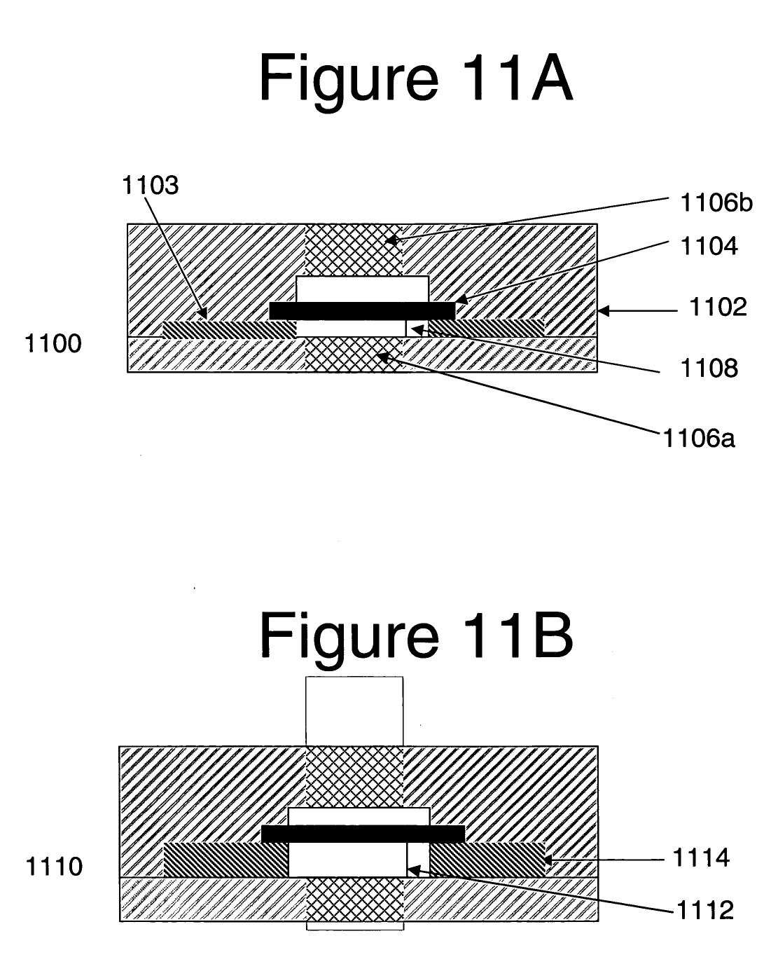

FIGS. 11(A) and 11(B) illustrate exemplary horizontally-oriented nanofabric switches. The fabrication of such switches is described in U.S. patent application Ser. No. 60/446,783, which is incorporated by reference in its entirety.

FIG. 11(A) illustrates a non-volatile switch much the same as that switch illustrated in FIG. 2, structure 200, the physical description of the make-up of a non-volatile vs. a volatile switch is described in reference to that structure, above. Structure 1100 is shown in cross section and includes; insulating layers 1102, supports 1103, nanofabric layer 1104, and electrodes 1106a and 1106b. Insulating layers 1102 are shown encapsulating the switch structure, however, depending on the desired use of the switch, other configurations are possible. Distance 1108 between nanofabric 1102 and electrode 1106a is shown and is not necessarily drawn to scale.

FIG. 11(B) illustrates a horizontally-oriented volatile switch. The physical characteristics and distance between fabric and electrode in relation to length of suspended portion of the fabric are much the same as the vertically-oriented switch shown in FIG. 2, structure 210. Note that distance 1112, shown in FIG. 11(B), is greater than distance 1108. The physical description of a volatile nanoswitch is described in reference to FIG. 2 above. Support 1114 is proportionally larger than the corresponding support in FIG. 11A.

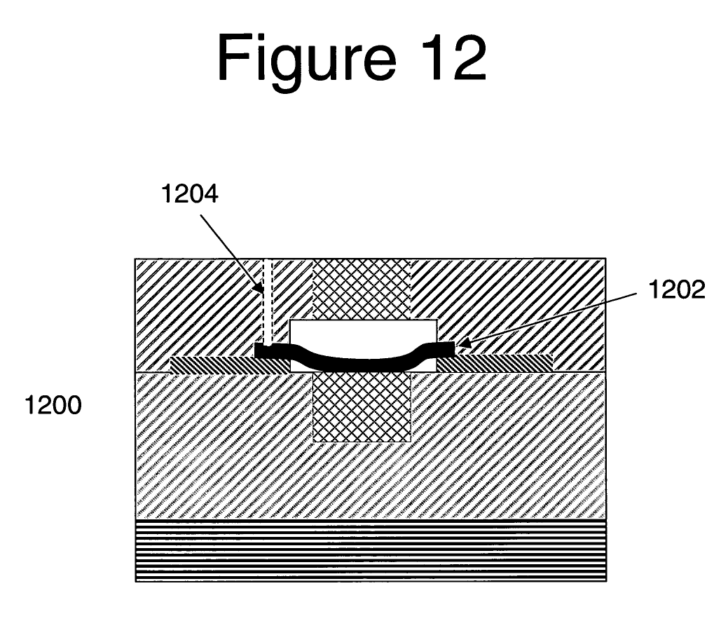

FIG. 12 illustrates a deflected nanofabric switch. Nanofabric 1202 is in contact with the lower electrode. An opening 1204 is shown as an example of the location for a via or plug, created subsequent to fabrication and encapsulation of the switch element. Such a via or plug is useful as part of a standard interconnect scheme.

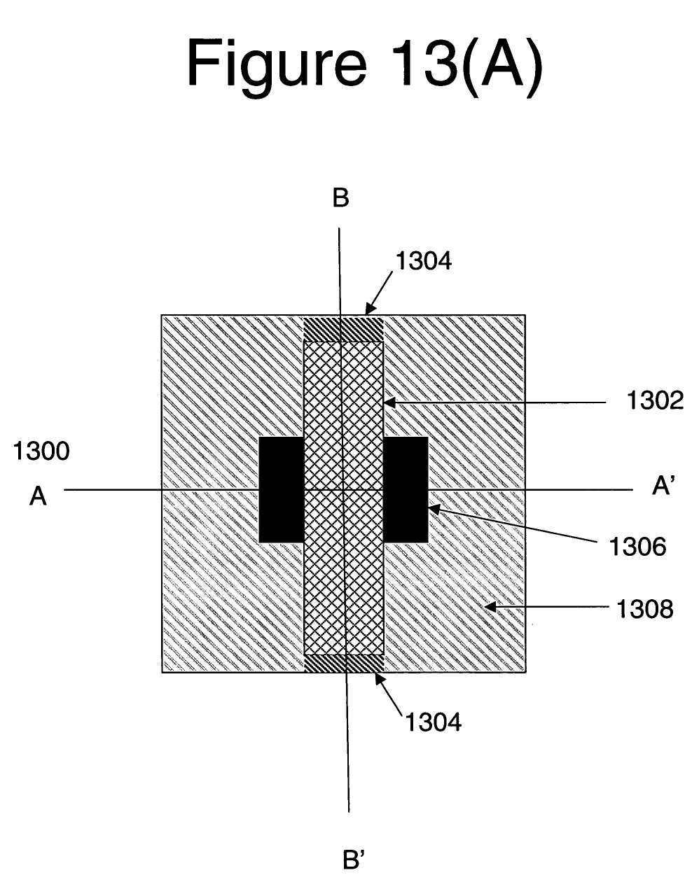

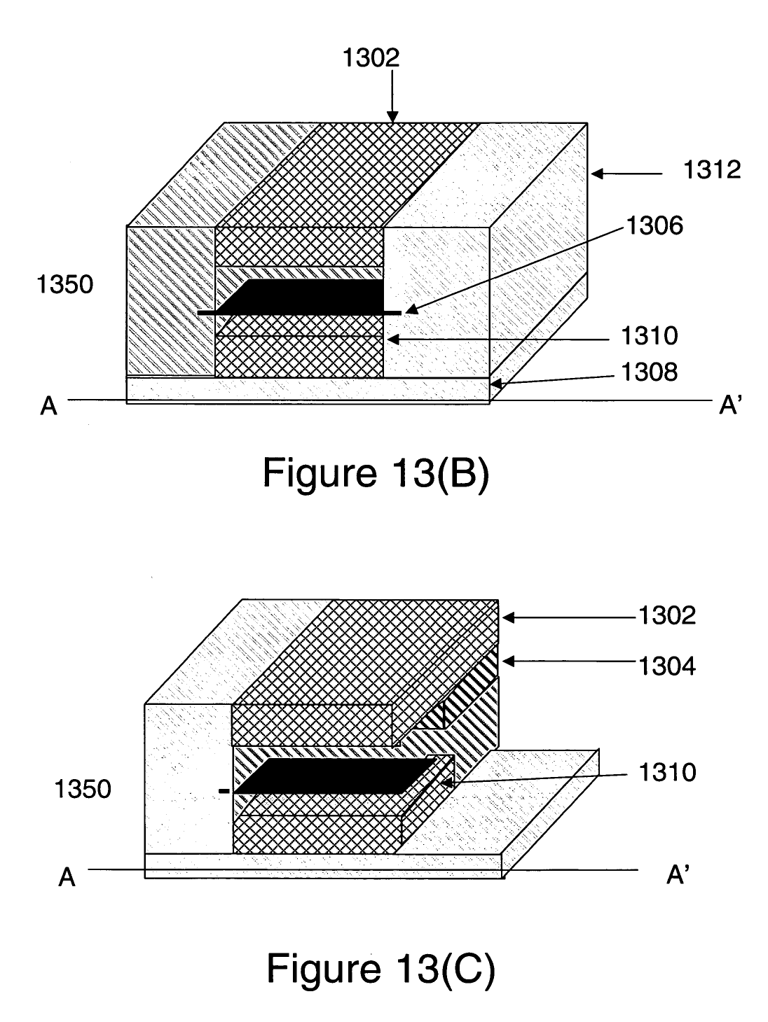

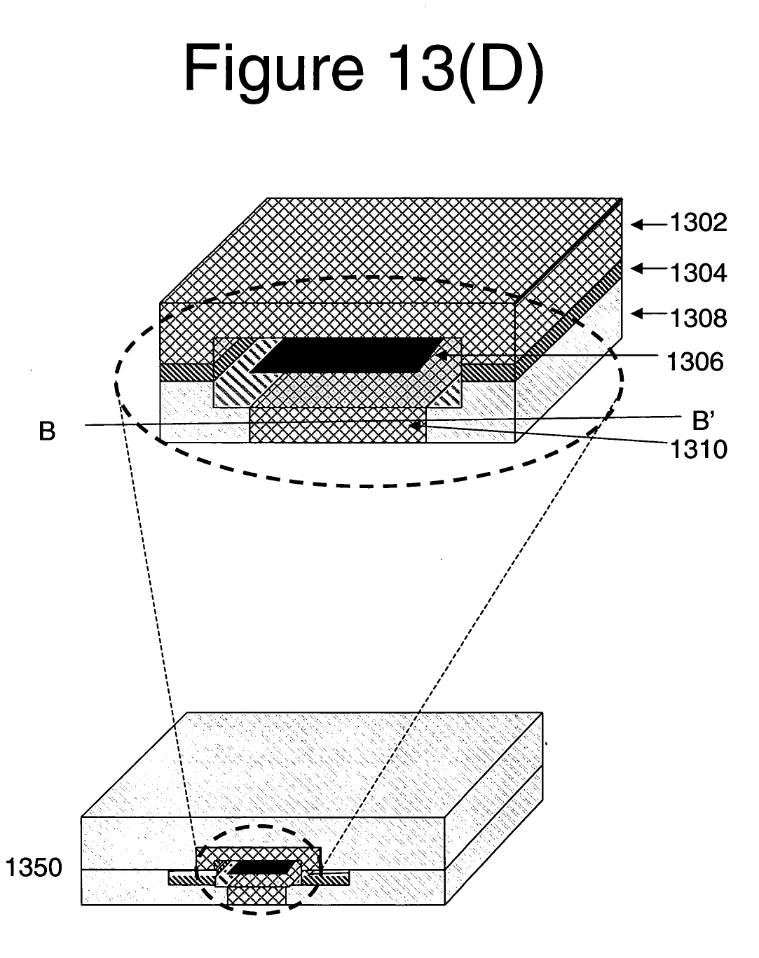

FIG. 13(A) is a plan view of intermediate structure 1300; intermediate structure 1300 having upper electrode 1302 resting on supports 1304, and above nanofabric 1306, (optional pinning structure are not shown). Nanofabric 1306 and supports 1304 are shown resting upon substrate 1308. The material selected for substrate 1308 can be any suitable insulating material including, but not limited to silicon oxide. Supports 1304 can be made from any appropriate insulating material and in many instances should be differently etchable over other insulating materials used in fabrication of the switching device, e.g. the material of supports 1304 may be nitride while the material of substrate 1308 may be silicon oxide; both are electrically insulating and are selectively etchable over one another.

FIGS. 13(B)-13(D) are perspective views of intermediate structure 1300 at cross sections A-A′ and B-B′ (structure 1300 is structure 1350 with the top insulating layers not shown for the sake of clarity).

FIG. 13(B) illustrates structure 1350 showing the elements of nanoswitch in cross section at A-A′ of FIG. 13(A) according to one aspect of the invention. Structure 1350 having lower electrode 1310 and top insulating material 1312.

FIGS. 13(C) and (D) illustrate two views of a nanoswitch according to one embodiment of the invention. An insulating substrate layer 1308 supporting lower electrode 1310 and insulating material 1312 is shown. Lower electrode 1310 is disposed below and not in contact with nanofabric 1306 which is fixed to insulating layer 1312. Insulating layer 1304 supports electrode material 1302.

FIG. 13(D) illustrates a view of a nanoswitch according to one aspect of the invention. The nanofabric 1306 as shown in this cross section does not appear to be contacting any other element, but as can be seen in FIG. 13(C), the nanofabric is contacting other elements, e.g. insulating layer 1312 (not shown in FIG. 13(D)). The exploded view (shown within the dotted lines) illustrates the interrelations of; insulating layer 1308, insulating layer 1304 and electrodes 1302 and 1310, as well as the location of nanofabric 1306 in reference to the aforementioned elements.

In yet another embodiment, the nanofabric can be suspended between electrodes containing metal or semiconducting material or the nanofabric may be suspended between electrodes containing semiconducting material, or it may be suspended between insulting layers. The latter configuration may be applied to sensor uses or other uses.

Other Embodiments

Fabrics composed of carbon nanotubes and nanowires of various materials can be used in certain embodiments of the present invention. Factors which must be considered when choosing the composition of the composite fabric include: elasticity, strain energy, heat dissipation, of the fabric needed in the final application of the element. A composite fabric of carbon nanotubes and nanowires may be made by spin coating a substrate with single solution of nanotubes and nanowires or by sequential spin coatings using solutions having suspended carbon nanotubes followed by one or more solutions having suspended single composition nanowires (I.e. apply carbon nanotubes in solution, then on the same substrate apply, e.g. silicon nanowires, then apply e.g. gold nanowires—this example is simply to explain what the inventors mean by sequential spin coatings—).

The nanotubes and nanowires may be applied by any appropriate means and the electrical characteristics of the nanotubes and nanowires may be controlled by controlling the composition and density of the fabric. If the fabric is to be deposited, pre-grown nanowires or pre-grown nanowires and nanotubes may be used. For example, under certain embodiments of the invention, nanowires, like nanotubes may be suspended in a solvent in a soluble or insoluble form and spin-coated over a surface to generate a composite nanotube/nanowire film. In such an arrangement the film created may be one or more nanowires thick, depending on the spin profile and other process parameters. Appropriate solvents include and are not limited to: dimethylformamide, n-methyl pyrollidinone, n-methyl formamide, orthodichlorobenzene, paradichlorobenzene, 1,2, dichloroethane, alcohols, water with appropriate surfactants such as sodium dodecylsulfate or TRITON X-100 or others. The nanotube/nanowire concentration and deposition parameters such as surface functionalization, spin-coating speed, temperature, pH and time can be adjusted for controlled deposition of monolayers or multilayers of nanotubes/nanowires as required.

There are other methods of depositing a nanofabric of nanotube/nanowire in addition to deposition and spin coating. The nanotube/nanowire film could also be deposited by dipping the wafer or substrate in a solution(s) of soluble or suspended nanotubes/nanowires. The film could also be formed by spraying the nanotube/nanowire in the form of an aerosol onto a surface. When conditions of catalyst composition and density, growth environment, and time are properly controlled, nanotube/nanowire can be made to evenly distribute over a given field that is primarily a monolayer of nanotubes/nanowires. Because nanotubes/nanowires are deposited on a surface at room temperature by spin-coating of a suspension of nanotubes/nanowires then the choice of substrate materials is expanded substantially over the choice of substrates used with high temperature applications. In this case there is no high temperature step and any material typically compatible with the device using nanowire fabrics would be acceptable.

The following are assigned to the assignee of this application, and are hereby incorporated by reference in their entirety:
Electromechanical Memory Having Cell Selection Circuitry Constructed With NT Technology (U.S. patent application Ser. No. 09/915,093), filed on Jul. 25, 2001;
Electromechanical Memory Array Using Nanotube Ribbons and Method for Making Same (U.S. patent application Ser. No. 09/915,173), filed on Jul. 25, 2001;
Hybrid Circuit Having NT Electromechanical Memory (U.S. patent application Ser. No. 09/915,095), filed on Jul. 25, 2001;
Electromechanical Three-Trace Junction Devices (U.S. patent application Ser. No. 10/033,323), filed on Dec. 28, 2001;
Methods of Making Electromechanical Three-Trace Junction Devices (U.S. patent application Ser. No. 10/033,032), filed on Dec. 28, 2001;
Nanotube Films and Articles (U.S. patent application Ser. No. 10/128,118), filed Apr. 23, 2002;
Methods of NT Films and Articles (U.S. patent application Ser. No. 10/128,117), filed Apr. 23, 2002;
Methods of Making Carbon Nanotube Films, Layers, Fabrics, Ribbons, Elements and Articles (U.S. patent application Ser. No. 10/341,005), filed on Jan. 13, 2003;
Methods of Using Thin Metal Layers to Make Carbon Nanotube Films, Layers, Fabrics, Ribbons, Elements and Articles (U.S. patent application Ser. No. 10/341,055), filed Jan. 13, 2003;
Methods of Using Pre-formed Nanotubes to Make Carbon Nanotube Films, Layers, Fabrics, Ribbons, Elements and Articles (U.S. patent application Ser. No. 10/341,054), filed Jan. 13, 2003;
Carbon Nanotube Films, Layers, Fabrics, Ribbons, Elements and Articles (U.S. patent application Ser. No. 10/341,130), filed Jan. 13, 2003;
Electro-Mechanical Switches and Memory Cells Using Horizontally-Disposed Nanofabric Articles and Methods of Making the Same, (U.S. Provisional Pat. Apl. Ser. No. 60/446,783), filed Feb. 12, 2003;
Electromechanical Switches and Memory Cells using Vertically-Disposed Nanofabric Articles and Methods of Making the Same (U.S. Provisional Pat. Apl. Ser. No. 60/446,786), filed Feb. 12, 2003; and
Non-volatile Field Effect Transistors and Methods of Forming Same (U.S. Pat. Apl. Ser. No. 60/476,976), filed on Jun. 9, 2003.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

1. An arbitrary electronic device using one of at least a switching element having a patterned article made from nanofabric or a conductive element having a patterned article made from nanofabric.
